(19) United States
(12) Patent Application Publication
(10) Pub. No.: US 2023/0391670 A1
(43) Pub. Date: Dec. 7, 2023

(54) HYBRID FIBER REINFORCED CEMENTITIOUS MATERIAL

(71) Applicant: Atlantis Holdings Ltd., Vancouver (CA)

(72) Inventor: Nemkumar BANTHIA, Vancouver (CA)

(73) Assignee: Atlantis Holdings Ltd., Vancouver, BC (CA)

(21) Appl. No.: 18/027,643

(22) PCT Filed: Sep. 22, 2021
(86) PCT No.: PCT/CA2021/051321

§ 371 Date: Mar. 22, 2023

Related U.S. Application Data
(60) Provisional application No. 63/081,792, filed on Sep. 22, 2020.

(51) Int. Cl. C04B 18/20; C04B 16/06; C04B 40/00

(52) U.S. Cl. CPC C04B 18/20; C04B 16/06; C04B 40/0032

(57) ABSTRACT

There is provided a cementitious mixture and method of making same. The cementitious mixture includes a cementitious material, aggregate and water. The cementitious mixture further includes a combination of fiber reinforcement, which includes a first amount of polymeric material fiber and a second amount of recycled polymeric fiber. According to embodiments, a relationship between the first amount of fiber and the second amount of fiber is defined by a ratio, wherein the ratio is between 1:7 and 7:1. The ratio of 1:7 is indicative of the total fiber in the cementitious mixture being 12.5% polymeric material fiber and 87.5% recycled polymeric fiber (RPF) and the ratio 7:1 is indicative of the total fiber in the cementitious mixture being 87.5% polymeric material fiber and 12.5% RPF fiber.

### CROSS-REFERENCE TO RELATED APPLICATIONS

This application claims the benefit of priority of U.S. Provisional Patent Application Ser. No. 63/081,792, entitled “Hybrid Fiber Reinforced Cementitious Material” and filed Sep. 22, 2020, the contents of which are incorporated herein by reference.

### FIELD OF THE INVENTION

The present invention pertains to the field of fiber reinforced cementitious material and in particular to a hybrid fiber reinforced cementitious material.

### BACKGROUND

Fiber reinforced concrete (FRO) is concrete containing fibrous material which increases its structural integrity. It contains short discrete fibers that are uniformly distributed and randomly oriented. Fibers can include steel fibers, glass fibers, synthetic fibers and natural fibers, wherein each of these fiber types lend varying properties to the concrete. In addition, the character of fiber-reinforced concrete changes with varying concretes, fiber materials, geometries, distribution, orientation, and densities.

Fibers are usually used in concrete to control cracking due to plastic shrinkage and drying shrinkage. Some types of fibers produce greater impact, abrasion, and shatter resistance in concrete.

The amount of fibers added to a concrete mix is expressed as a percentage of the total volume of the composite (concrete and fibers), termed “volume fraction” (V_{f}). V_{f} typically ranges from 0.1 to 3%. The aspect ratio (l/d) of the fiber is typically calculated by dividing fiber length (l) by its diameter (d). Fibers with a non-circular cross section use an equivalent diameter for the calculation of aspect ratio. If the modulus of elasticity of the fiber is higher than the matrix (e.g. the concrete or mortar binder), the fibers can help to carry the load by increasing the tensile strength of the material. Increasing the aspect ratio of the fiber usually segments the flexural strength and toughness of the matrix. However, fibers that are too long tend to “ball” in the mix and create workability problems.

As previously noted, fibers can be formed from a variety of materials which can include glass, polypropylene, nylon, polyvinyl alcohol (PVA) and steel among other materials. There has also been research that discloses the use of polymeric scrap tire fiber as fiber reinforcement in cementitious materials. As an example, polypropylene and nylon fibers can improve aspects of a concrete mix which can include freeze thaw resistance, impact and abrasion resistance, ductility and reduction of cracks widths.

There has been a significant effort towards developing and researching a new class of FRC, called Eco-Friendly Ductile Cementitious Composites (EDCC). EDCC exhibits strain-hardening behavior and high strain capacity in bending even with low volumes of fibers. This unique strain-hardening/deflection-hardening behavior results from an elaborate design using a micro-mechanical model taking into account the interactions between fiber, matrix and the fiber-matrix interface.

At this time, the most preferred fiber for use in EDCC is the polyvinyl alcohol (PVA) fiber with a diameter of 39 μm and a length of 6 to 12 mm. However, challenges of using PVA fiber in producing EDCC is that the PVA is expensive and PVA can develop a strong bond with the cement-based matrix due to the presence of hydroxyl groups in the molecular chains. This high chemical bond can promote fiber rupture which may limit the tensile strain capacity of the resulting composite.

Accordingly, there may be a need for a new fiber reinforced cementitious material and method of making same that is not subject to one or more limitations of the prior art.

This background information is intended to provide information that may be of possible relevance to the present invention. No admission is necessarily intended, nor should be construed, that any of the preceding information constitutes prior art against the present invention.

### SUMMARY

It is an object of the present invention to obviate or mitigate at least one disadvantage of the prior art.

According to an aspect of the present invention, there is provided a cementitious mixture. The cementitious mixture including cementitious material, aggregate and water. The cementitious mixture further including a first amount of polymeric material fiber and a second amount of recycled polymeric fiber (for example, scrap tire fiber). The first amount and the second amount are defined by a ratio, wherein the ratio is between 1:7 and 7:1.

In some embodiments, the ratio is between 1:4 and 4:1. In some embodiments, the ratio is between 1:3 and 3:1. In some embodiments, the ratio is between 1:2 and 2:1. In some embodiments, the ratio is 1:1.

According to another aspect of the present invention there is provided a method of making a cementitious mixture, wherein the cementitious mixture includes a cementitious material, aggregate, water, a first amount of polymeric material fiber and a second amount of recycled polymeric fiber (RPF). The first amount and the second amount are defined by a ratio, the ratio between 1:7 and 7:1. The method includes mixing the cementitious material and the aggregate for a first period of time and adding the polymeric material fiber and the RPF fiber and continuing to mix for a second period of time. The method further includes adding half to three quarters of the water and continuing to mix for a third period of time and adding the remaining water and continuing to mix for a fourth period of time

Embodiments have been described above in conjunction with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 illustrates 7 day and 28 day compressive strength results of three different cementitious mixtures according to embodiments.

FIG. 2 illustrates comparative compressive strength results of three different cementitious mixtures with difference sand sizes according to embodiments.

FIG. 3 illustrates a full flexural response of a cementitious mixture including 2% STF with 0.8 mm sand size, according to embodiments.

FIG. 4 illustrates a full flexural response of a cementitious mixture including 2% STF with 0.6 mm sand size, according to embodiments.

FIG. 5 illustrates a full flexural response of a cementitious mixture including 2% PVA with 0.8 mm sand size, according to embodiments.

FIG. 6 illustrates a full flexural response of a cementitious mixture including 2% PVA with 0.6 mm sand size, according to embodiments.

FIG. 7 illustrates a full flexural response of a cementitious mixture including 1% PVA and 1% STF with 0.8 mm sand size, according to embodiments.

FIG. 8 illustrates a full flexural response of a cementitious mixture including 1% PVA and 1% STF with 0.6 mm sand size, according to embodiments.

FIG. 9 illustrates a full flexural response of a cementitious mixture including 0.5% PVA and 1.5% STF with 0.8 mm sand size, according to embodiments.

FIG. 10 illustrates a full flexural response of a cementitious mixture including PVA and 1.5% STF with 0.6 mm sand size, according to embodiments.

FIG. 11 illustrates a full flexural response of a cementitious mixture including 1.5% PVA and 0.5% STF with 0.8 mm sand size, according to embodiments.

FIG. 12 illustrates a full flexural response of a cementitious mixture including 1.5% PVA and 0.5% STF with 0.6 mm sand size, according to embodiments.

FIG. 13 illustrates a flexural response of cementitious mixtures with 0.8 mm sand size and varying fiber ratios, according to embodiments.

FIG. 14 illustrates a flexural response of cementitious mixtures with 0.6 mm sand size and varying fiber ratios, according to embodiments.

FIG. 15 illustrates a flexural response of cementitious mixtures with 0.8 mm sand size and varying fiber ratios, according to embodiments.

FIG. 16 illustrates a flexural response of cementitious mixtures with 0.6 mm sand size and varying fiber ratios, according to embodiments.

FIG. 17 illustrates a flexural response of cementitious mixtures with 0.8 mm sand size and varying fiber ratios, according to embodiments.

FIG. 18 illustrates a flexural response of cementitious mixtures with 0.6 mm sand size and varying fiber ratios, according to embodiments.

FIG. 19 illustrates a flexural response of cementitious mixtures with 0.8 mm sand size and varying fiber ratios, according to embodiments.

FIG. 20 illustrates a flexural response of cementitious mixtures with 0.6 mm sand size and varying fiber ratios, according to embodiments.

FIG. 21 illustrates beam kinematics relating deflection to crack opening.

FIG. 22 illustrates energy absorption vs deflection for cementitious mixtures with sand size for varying fiber ratios, according to embodiments.

FIG. 23 illustrates energy absorption vs deflection for cementitious mixtures with sand size for varying fiber ratios, according to embodiments.

FIG. 24 illustrates a method of making a cementitious mixture in accordance with embodiments.

### DETAILED DESCRIPTION

Polyvinyl alcohol (PVA) fiber is popular for the fabrication of FRC. However, challenges relating to the use of PVA fiber can be expense and the potential to develop too strong a bond with the cement-based matrix which may promote fiber rupture possibly limiting tensile strain capacity of the resulting composite. In order to achieve a strain-hardening behavior it has been suggest that the resulting bond between the fiber and matrix should be lowered to an optimal range. Currently this may be achieved by oiling the PVA fiber. As would be understood, this is not practical solution for an FRC composite, especially when the PVA fiber is an expensive material.

There is a substantial amount of polymer material that is available by the recycling of products including products including polymer material. According to embodiments, fiber formed from recycled polymer material are herein defined as recycled polymeric fiber (RPF). For example, recycled polymeric fiber can include fibers created from recycled plastic bottles, which can be originally fabricated from polyethylene-terephthalate (PET). Recycled polymeric fiber can also include polymeric scrap tire fiber (STF) which may also be called repurposed tire fiber (RPF). STF or RPF is one of the by-products derived from the processing of discarded vehicle tires. Presently, significant quantities of STF are generated annually in most developed countries of the world. However, and unfortunately, STF uses have been limited. A recent report by Tire Stewardship British Columbia (TSBC) indicates that while a significant quantity of rubber residue is used as fuel, a very small percentage of STF is put to value-added use.

According to embodiments, recycled polymeric fiber (RPF) can be used to define fiber from any form of recycled polymeric material. For example, RPF can include fibers that are formed from recycled polyvinyl alcohol (PVA), recycled polyethylene-terephthalate (PET), recycled polypropylene, recycled polyester, recycled scrap tire fiber or repurposed tire fiber or other recycled polymeric material. In some embodiments, RPF can further included fiber that is formed from recycled cellulose.

It will be readily understood that “scrap tire fiber” (STF) may also be defined as “repurposed tire fiber” (RTF) or by other suitable terminology that may be used to define fibers that may be derived from the recycling of tires. STF or RTF can include one or more of a variety of different types of fibers used in tire manufacturing which may include one or more of polyvinyl alcohol (PVA), polyethylene-terephthalate (PET), polypropylene, polyester or other polymeric material as would be readily understood by a worker skilled in the art.

It has been realized that there is an unexpected result with respect to the flexural performance of a cementitious mixture having a hybrid fiber composition, namely the fiber in the cementitious mixture is a blend of polymeric material fibers and recycled polymeric fibers (RPF) (e.g. STF fibers). This unexpected synergy between the polymeric material fiber and the RPF fiber results in similar flexural performance features of a cementitious mixture with a hybrid fiber mix when compared to a cementitious mixture with solely polymeric fibers. This synergistic performance of polymeric material fibers and RPF fibers can provide a means for not only cost savings during cementitious mixture manufacture relating to the reduction is polymeric material fibers required, but can further aid with the mitigation of the waste which may occur due to recycling, for example the recycling of tires, by the use of the RPF fibers (e.g. STF fibers) in the cementitious mixtures. This is in fact a double win scenario as such, based on an unexpected synergy of polymeric material fibers and RPF fibers in the performance of cementitious mixtures which include this hybrid fiber mix, there can be a cost savings and improved environmental impact of the cementitious mixture.

There is provided a cementitious mixture that includes a cementitious material, aggregate and water. The cementitious mixture further includes a combination of fiber reinforcement, which includes a first amount of polymeric material fiber and a second amount of recycled polymeric fiber (RPF). According to embodiments, a relationship between the first amount of fiber and the second amount of fiber is defined by a ratio, wherein the ratio is between 1:7 and 7:1. The ratio of 1:7 is indicative of the total fiber in the cementitious mixture being 12.5% polymeric material fiber and 87.5% recycled polymeric fiber (RPF) and the ratio 7:1 is indicative of the total fiber in the cementitious mixture being 87.5% polymeric material fiber and 12.5% RPF fiber.

According to embodiments, the relationship between the first amount of fiber and the second amount of fiber is defined by the ratio between 1:4 and 4:1. The ratio of 1:4 is indicative of the total fiber in the cementitious mixture being 20% polymeric material fiber and 80% recycled polymeric fiber (RPF) and the ratio 4:1 is indicative of the total fiber in the cementitious mixture being 80% polymeric material fiber and 20% RPF fiber.

According to embodiments, the relationship between the first amount of fiber and the second amount of fiber is defined by the ratio between 1:3 and 3:1. The ratio of 1:3 is indicative of the total fiber in the cementitious mixture being 25% polymeric material fiber and 75% recycled polymeric fiber (RPF) and the ratio 4:1 is indicative of the total fiber in the cementitious mixture being 75% polymeric material fiber and 25% RPF fiber.

According to embodiments, the relationship between the first amount of fiber and the second amount of fiber is defined by the ratio between 1:2 and 2:1. The ratio of 1:2 is indicative of the total fiber in the cementitious mixture being 33.3% polymeric material fiber and 66.7% recycled polymeric fiber (RPF) and the ratio 2:1 is indicative of the total fiber in the cementitious mixture being 66.7% polymeric material fiber and 33.3% RPF fiber.

According to embodiments, the relationship between the first amount of fiber and the second amount of fiber is defined by the ratio of 1:1, which is equal proportions of the polymeric material fiber and the RPF fiber.

According to embodiments, RPF can include fibers that are formed from recycled polyvinyl alcohol (PVA), recycled polyethylene-terephthalate (PET), recycled polypropylene, recycled polyester, recycled scrap tire fiber or other recycled polymeric material. In some embodiments, RPF can further included fiber that is formed from recycled cellulose. According to some embodiments, the recycled polymeric fiber (RPF) is scrap tire fiber (STF) or repurposed tire fiber (RPF).

According to some embodiments, the recycled polymeric fiber can have a varying aspect ratio, wherein the length of the RPF can vary between 3 to 5 mm and the diameter of the RPF can vary between 18 to 20μ. It will be readily understood that other aspect ratios of RPF may be used and would be considered to fall within the scope of the instant application. Furthermore, depending on the type of RPF used, the aspect ratio of the fiber can be defined by the process of processing the source of the recycled material (e.g. plastic bottles) in order to provide RPF having a desired aspect ratio.

According to embodiments, the polymeric material fibers are formed from polyvinyl alcohol (PVA), polyethylene-terephthalate (PET), polypropylene, polyester or other polymeric material as would be readily understood by a worker skilled in the art.

The total amount of all fibers, namely the total amount of polymeric material fibers and RPF fibers, within the cementitious mixture can be defined by a volume fraction, wherein the volume fraction defines the amount of fiber relative to the total volume of the cementitious mixture. In some embodiments, the total fibers in the cementitious mixture can range between 0.1% to 4% by volume. In some embodiments, the total fibers in the cementitious mixture can range between 1% to 3% by volume. In some embodiments, the total fibers in the cementitious mixture are approximately 2% by volume.

According to embodiments, the amount of RPF fibers in the cementitious mixture can be dependent on the desired level of synergy between the polymeric material fibers and the RPF fibers, wherein the level of synergy may define flexural performance, ductility, toughness or other behavioural aspect of the cementitious mixture. In some embodiments, the amount of RPF fibers in the cementitious mixture can be dependent on the specific application for which the cementitious mixture is being manufactured. In some embodiments, the amount of RPF fibers in the cementitious mixture can depend on the desired level of environmental impact based on the amount of RPF fibers used.

According to some embodiments, the separation of the RPF fibers obtained from the recycling of tires can be separated from the crumb rubber using a variety of methods. For example, gravitational methods can be used wherein separation can be made possible based on the differential density between the crumb rubber and the polymeric material fibers. As an alternate separation method, dissolution separation can be used wherein solvents can be used to remove the attached crumb rubber from the polymeric material fibers. It will be readily understood that all of the crumb rubber may not be removed from the RPF (e.g. STF) fibers, and thus there may be some residue of rubber on at least some of the RPF fibers. For example, there may be residue of approximately 50 wt % of fine crumb rubber on the STF.

According to embodiments, the cementitious mixture includes a cementitious. material which forms the binder of the cementitious mixture. The cementitious material can be a general use (GU) Portland cement, high performance cement, geopolymer cement or other cementitious material that can be used as the binder as would be readily understood by a worker skilled in the art. For example, as would be readily understood other cementitious materials for use as a binder may include ordinary Portland cement (OPC), Portland limestone cement (PLC). Furthermore, as would be readily understood by a worker skilled in the art, a cementitious material for use as a binder can take the form of a magnesium based binder, a phosphogypsum based binder, biocement based binder, perlite based binder and the like. It would be further readily understood by a worker skilled in the art, that the cementitious material for use as a binder can further include fly ash or other similar material.

Geopolymer cement requires an aluminosilicate precursor material such as metakaolin or fly ash, alkaline reagent which is typically user-friendly (for example, sodium or potassium soluble silicates with a molar ratio MR SiO₂:M₂O≥1.65, M being Na or K) and water. Geopolymer cement recipes employed in the field generally involve alkaline soluble silicates with starting molar ratios ranging from 1.45 to 1.95, particularly 1.60 to 1.85, which can provide user-friendly conditions. However, it may happen some recipes have molar ratios in the 1.20 to 1.45 range, however these molar ratios are typically for research in laboratory settings. The room temperature hardening of the geopolymer cement is more readily achieved with the addition of a source of calcium cations, for example blast furnace slag. There are a variety of geopolymer cements which can include slag-based geopolymer cement, rock-based geopolymer cement, fly ash-based geopolymer cement and ferro-sialate-based geopolymer cement.

According to embodiments, the cementitious mixture further includes aggregate which can be solely a fine aggregate, for example sand or can be a combination of a fine aggregate and coarse aggregate. The selection of the aggregate can be determined based on one or more of the desired characteristics of the cementitious mixture, the intended use of the cementitious mixture, the intended method of placement of the cementitious mixture or a combination or other desired characteristic as would be readily understood. In some embodiments, the aggregate is a fine aggregate with a sand size of one or more of 1 mm or or 0.6 mm or 0.4 mm or other suitable sand size as would be readily understood. In addition, as would be understood when coarse aggregate is used in the cementitious mixture, the size of the coarse aggregate can be dependent the application of the cementitious mixture as well as the type of cementitious material used as the binder, for example smaller coarse aggregate is used in high performance concrete.

Furthermore, as would be readily understood, the aggregate for use in the cementitious mixture can be a recycled aggregate, a lightweight aggregate which may include one or both of natural lightweight aggregate and artificial lightweight aggregate, alkali-activated materials, waste glass or recycled glass or other form of aggregate as would be readily understood.

According to embodiments, the cementitious mixture can further include one or more additives which can include superplasticizer, water reducer, air entrainment, retarders accelerators or other additives as would be readily understood. It would be readily understood that these additives may include one or more of internal curing compounds and sequestered carbon dioxide. It is understood that the inclusion of one or more additives can be dependent on a variety of variables that can include but not limited to the type of cementitious material is used for the binder, the desired water to cement ratio, use of the cementitious mixture, the placement method of the cementitious mixture or the like.

As would be readily understood the recipe for the base cementitious mixture, which is a combination of at least the cement material, aggregate and water can also be dependent on a variety of variables that can include but not limited to the type of cementitious material is used for the binder, the desired water to cement ratio, use of the cementitious mixture, the placement method of the cementitious mixture or the like.

In some embodiments, the cementitious mixture further includes one or more of fly ash and silica fume. Other materials can be added to the cementitious mixture as would be readily understood by a worker skilled in the art.

According to embodiments, a relatively standard mixture procedure for fibre reinforced concrete can be followed, wherein the relatively standard mixture procedure can be determined based on the type of materials included with cementitious mixture and the type of cementitious material is used for the binder. In some embodiments, as discussed elsewhere herein, a specific mixing procedure can be followed wherein dry material (e.g. cementitious material and aggregate) is mixed for a period of time, mixing in the fiber and continuing to mix for a first period of time, thereafter adding half to three quarters of the water and continuing to mix for a second period of time and finally adding the remaining water and continuing to mix for a third period of time.

Experiments were performed in order to evaluate the performance of multiple cementitious mixtures with different fiber ratios, wherein the fibers used were PVA fibers and STF fibers. For consistency, the cementitious mixtures without fiber were the same and into each of these cementitious mixtures, fibers were added, wherein there were varying ratios relating to the type of fiber used in the cementitious mixtures.

The information regarding the mixture proportion and fiber combinations used in this study is given in TABLE 1 and TABLE 2. In particular, TABLE 1 outlines the base cementitious mixture that was consistently used and TABLE 2 defines the three different fiber ratios that were evaluated. As can be seen from TABLE 2, there are essentially two control cementitious mixtures being prepared, namely a first with just PVA fiber (2% PVA) and a second with solely STF fiber (2% STF). The third mixture is a blend of both PVA fivers and SFT fibers.

A specific mixing procedure was followed. Sand, fly ash, silica fume and General Use (GU) Portland cement were first premixed for 2 minutes, fiber was then added and the mixing continued for a further three minutes. Thereafter, approximately two thirds of the mixing water was added and mixed for an additional two minutes, then the remaining water was added and mixing continued for the last 2 minutes.

TABLE 1

| Materials | kg/m³ |
|---|---|
| Cement (GU) | 385 |
| Fly ash, Class C | 770 |
| Silica fume | 77 |
| Sand (0.8 mm and 0.6 mm) | 462 |
| Potable Water | 333 |
| Superplasticizer SP ADVA 298 | 2 L/m³ |

TABLE 2

Fibers (by Volume)

| Mixture | PVA | STF |
|---|---|---|
| Mix I | 1% | 1% |
| Mix II | 1.5% | 0.5% |
| Mix V | 2% | — |
| Mix VI | — | 2% |
| Mix VII | 0.5% | 1.5% |

For all mixtures, flexural beam molds and cylindrical molds were filled with the cementitious mixtures, and then vibrated to consolidate the matrix. After finishing the casting, all specimens were covered with a plastic sheet to minimize moisture loss, and allowed to cure for 24 hours. Thereafter, specimens were de-molded, and subjected to a moist curing regiment. All testing was performed after 28 days of moist-curing.

For each mix, at least three 75×150 mm cylinder specimens were tested. The loading rate during the compression test was maintained at 0.24 MPa/sec. For flexural beam testing, a “third-point loading” fixture is used with two support points below the beam specimen and two loading noses on the top of the beam specimen. For each mix, six 50×50×240 mm specimens were tested on a span of 150 mm. A net deflection of a beam was determined by averaging the measurements of two linear variable displacement transducers.

FIG. 1 illustrates 7 day and 28 day compressive strength results of three different cementitious mixtures according to embodiments. It is noted that these specimens were moist cured up to testing. As can be seen, there is no significant difference in compressive strength between the mixtures at both 7 and 28 days. FIG. 2 illustrates comparative compressive strength results of three different cementitious mixtures with different sand sizes according to embodiments. It is noted that a reduction in the maximum grain size of the fine aggregate, shows that the compressive strength of a cementitious mixture generally increased.

Based on compressive strength data, it is clear that after 7 and 28 days of moist-curing, there is no significant difference in strength for all mixtures. This result is not surprising given that it is well-established that micro-fibers have minimal effect on the compressive strength of cement-based composites. However, with a reduction in the maximum grain size of the fine aggregate, in this case the sand, FIG. 2 shows that the compressive strength of the cementitious mixtures generally increased. Although the effect of maximum grain size of sand on compressive strength is dependent on the proportion of hybrid fiber in a given mix, it does appear that the finer the grain size of the sand, the particle packing of the matrix is more efficient thus aiding with the increase in compressive strength.

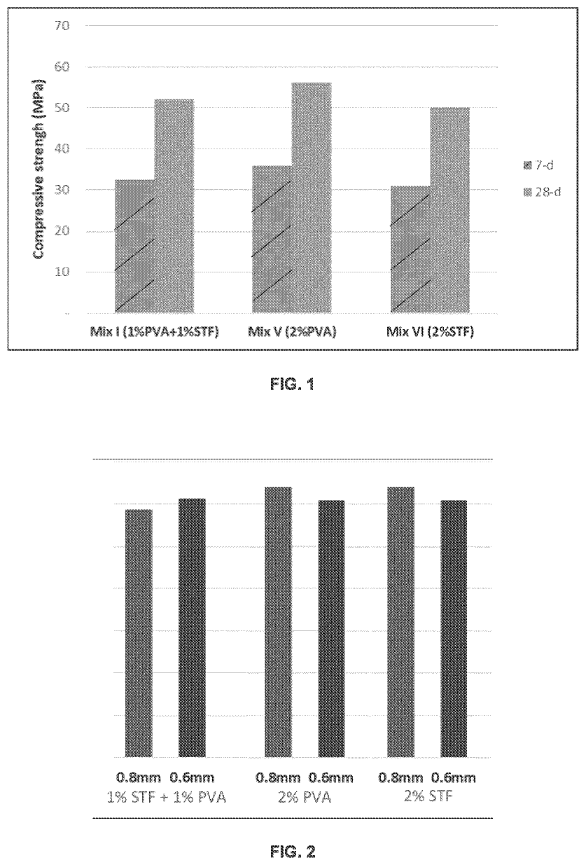

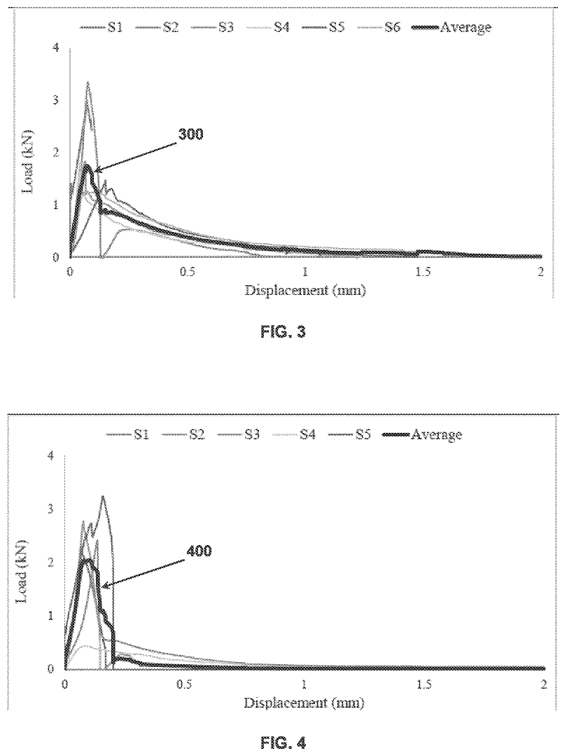

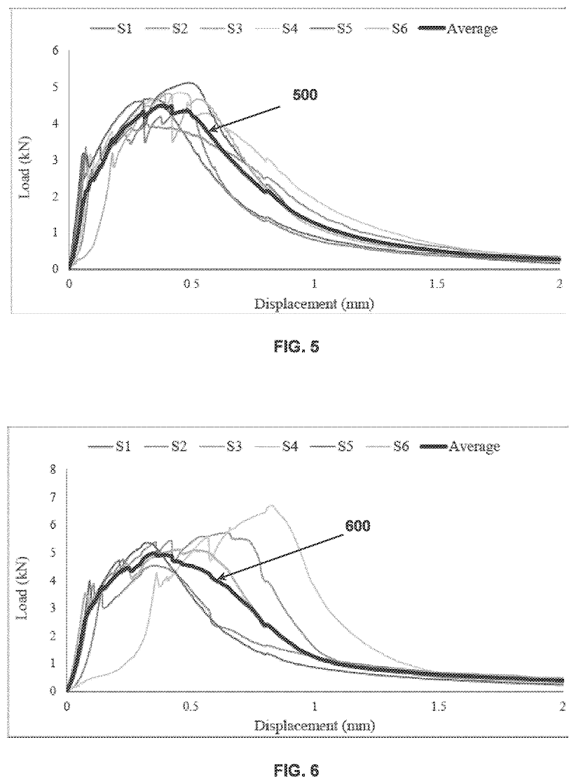

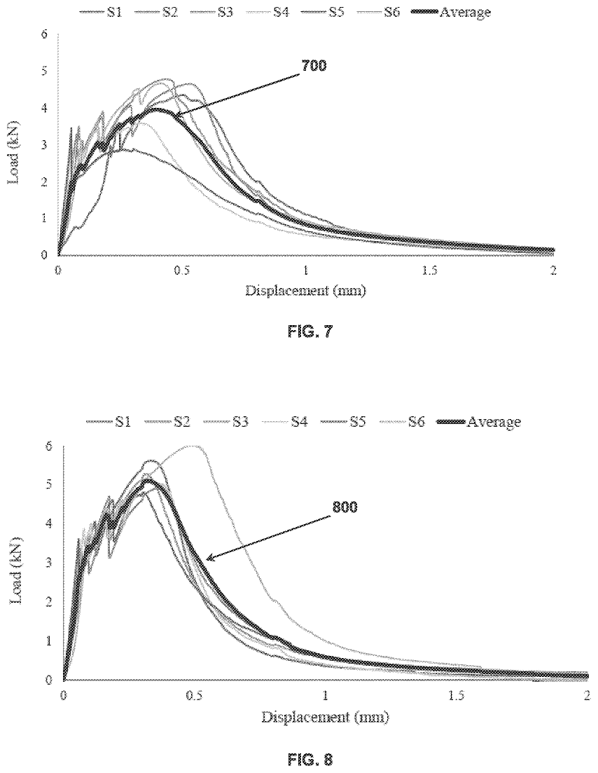

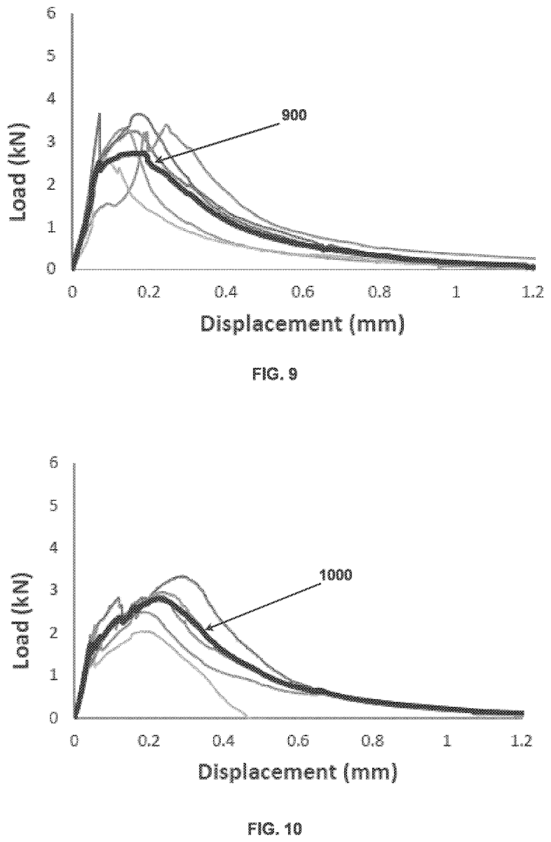

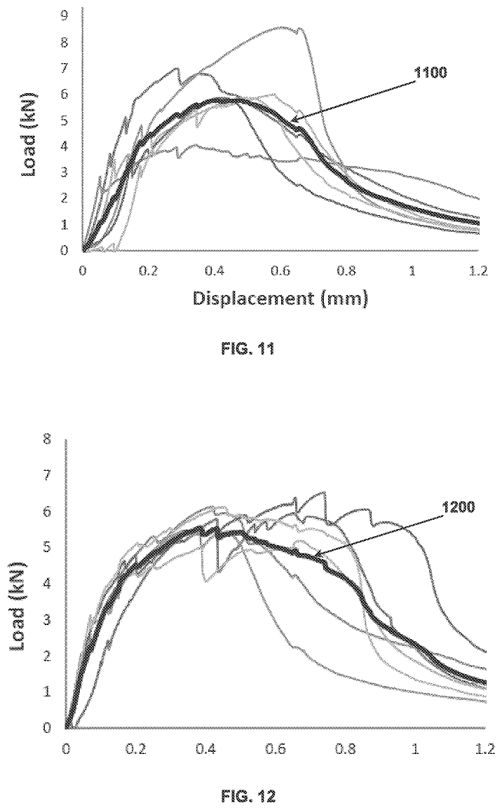

The flexural load verses displacement curves of the cementitious mixtures cast as beams are shown in FIGS. 3 to 8. It is noted that for each of these cementitious mixtures, six specimens were tested and an average flexural response for each cementitious mixture is determined. Each of these plots include all six specimens and an identification of the average flexural response to be used for comparisons. In particular, FIG. 3 illustrates a full flexural response of a cementitious mixture including 2% STF with 0.8 mm sand size, according to embodiments, including the average flexural response 300 for the multiple specimens. The average flexural response is defined by FIG. 4 illustrates a full flexural response of a cementitious mixture including 2% STF with 0.6 mm sand size, according to embodiments, including the average flexural response 400 for the multiple specimens. FIG. 5 illustrates a full flexural response of a cementitious mixture including 2% PVA with 0.8 mm sand size, according to embodiments, including the average flexural response 500 for the multiple specimens. FIG. 6 illustrates a full flexural response of a cementitious mixture including 2% PVA with 0.6 mm sand size, according to embodiments, including the average flexural response 600 for the multiple specimens. FIG. 7 illustrates a full flexural response of a cementitious mixture including 1% PVA and 1% STF with 0.8 mm sand size, according to embodiments, including the average flexural response 700 for the multiple specimens. FIG. 8 illustrates a full flexural response of a cementitious mixture including 1% PVA and 1% STF with 0.6 mm sand size, according to embodiments, including the average flexural response 800 for the multiple specimens. FIG. 9 illustrates a full flexural response of a cementitious mixture including 0.5% PVA and 1.5% STF with 0.8 mm sand size, according to embodiments, including the average flexural response 900 for the multiple specimens. FIG. 10 illustrates a full flexural response of a cementitious mixture including PVA and 1.5% STF with 0.6 mm sand size, according to embodiments, including the average flexural response 1000 for the multiple specimens. FIG. 11 illustrates a full flexural response of a cementitious mixture including 1.5% PVA and 0.5% STF with 0.8 mm sand size, according to embodiments, including the average flexural response 1100 for the multiple specimens. FIG. 12 illustrates a full flexural response of a cementitious mixture including 1.5% PVA and 0.5% STF with 0.6 mm sand size, according to embodiments, including the average flexural response 1200 for the multiple specimens.

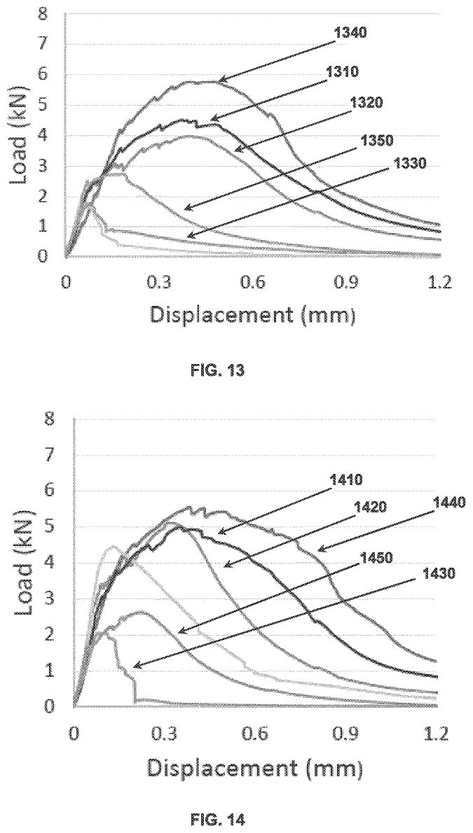

FIG. 13 illustrates a flexural response of cementitious mixtures with 0.8 mm sand size and varying fiber ratios, according to embodiments up to a total deflection of 1.2 mm. In particular, it is clear that the flexural response of a cementitious mixture having 2% PVA 1310, is significantly better than the flexural response of a cementitious mixture having 2% STF 1330. It is also clear that the cementitious mixture having a hybrid of fibers, namely 1% PVA+1% STF 1320, has a flexural response that is very similar to that of the cementitious mixture having 2% PVA, however the total load capacity is lower than that of the 2% PVA fiber cementitious mixture. For further comparison, a cementitious mixture having a hybrid of fibers at 1.5% PVA+0.5% STF 1340 as well as a cementitious mixture having a hybrid of fibers at 0.5% PVA+1.5% oSTF 1350.

It is important to note that the response of the cementitious mixture having a hybrid of fibers is not just a mere additive response of the cementitious mixtures having solely PVA fibers or solely STF fibers. For example, the flexural performance of the cementitious mixture having a hybrid of fibers is not an average of the responses of the cementitious mixtures with solely PVA fibers and solely SFT fibers. In fact, based on the results illustrated in FIG. 13, there is a level of synergy between the PVA fibers and the STF fibers in the hybrid fiber cementitious mixture resulting in a flexural performance of the cementitious mixture having a hybrid of fibers being dramatically better than a mere average of the responses of the cementitious mixtures with solely PVA fibers and solely SFT fibers.

FIG. 14 illustrates a flexural response of cementitious mixtures with 0.6 mm sand size and varying fiber ratios, according to embodiments up to a total deflection of 1.2 mm. In particular, it again can be seen that the flexural response of a cementitious mixture having 2% PVA 1410, is significantly better than the flexural response of a cementitious mixture having 2% STF 1430. It is also noted that the cementitious mixture having a hybrid of fibers, namely 1% PVA+1% STF 1420, has a flexural response that is very similar to that of the cementitious mixture having 2% PVA up to a peak load, however there is a quicker load drop off as displacement increases. As such, it can be noted that with a 0.6 mm sand size the flexural response of the cementitious mixture having a hybrid of fibers, namely 1% PVA+1% STF is substantially the same as that of a cementitious mixture having 2% PVA fibers. For further comparison, a cementitious mixture having a hybrid of fibers at 1.5% PVA+0.5% STF 1440 as well as a cementitious mixture having a hybrid of fibers at 0.5% PVA+1.5% STF 1450.

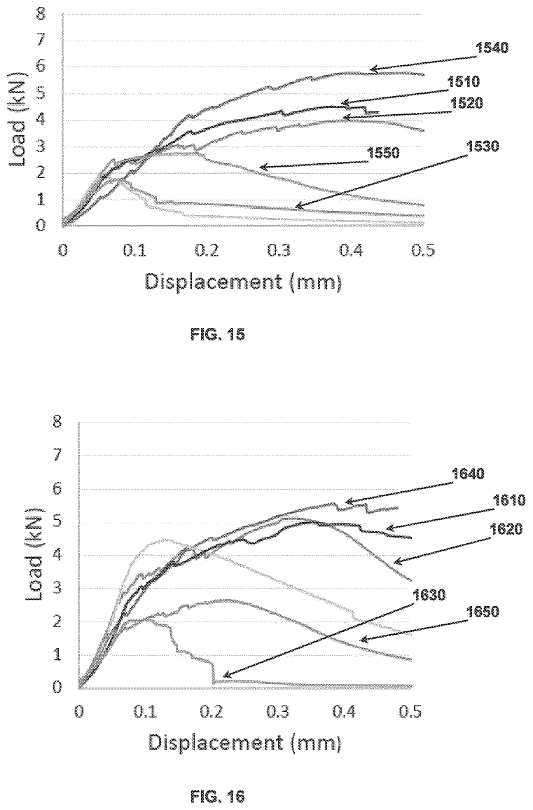

FIG. 15 illustrates a flexural response of cementitious mixtures with 0.8 mm sand size and varying fiber ratios, according to embodiments, up to a deflection of 0.5 mm. FIG. 15 shows the flexural response of a cementitious mixture having 2% PVA 1510, the flexural response of a cementitious mixture having 2% STF 1530. The flexural response of a cementitious mixture having a hybrid of fibers is also illustrated, namely 1% PVA+1% STF 1520, 1.5% PVA+0.5% STF 1540 and 0.5% PVA+1.5% STF 1550.

FIG. 16 illustrates a flexural response of cementitious mixtures with 0.6 mm sand size and varying fiber ratios, according to embodiments, up to a total deflection of 0.5 mm.

FIG. 16 shows the flexural response of a cementitious mixture having 2% PVA 1610, the flexural response of a cementitious mixture having 2% STF 1630. The flexural response of a cementitious mixture having a hybrid of fibers is also illustrated, namely 1% PVA+1% STF 1620, 1.5% PVA+0.5% STF 1640 and 0.5% PVA+1.5% STF 1650.

FIG. 17 illustrates a flexural response of cementitious mixtures with 0.8 mm sand size and varying fiber ratios, according to embodiments, up to a deflection of 0.4 mm. FIG. 17 shows the flexural response of a cementitious mixture having 2% PVA 1710, the flexural response of a cementitious mixture having 2% STF 1730. The flexural response of a cementitious mixture having a hybrid of fibers is also illustrated, namely 1% PVA+1% STF 1720, 1.5% PVA+0.5% STF 1740 and 0.5% PVA+1.5% STF 1750.

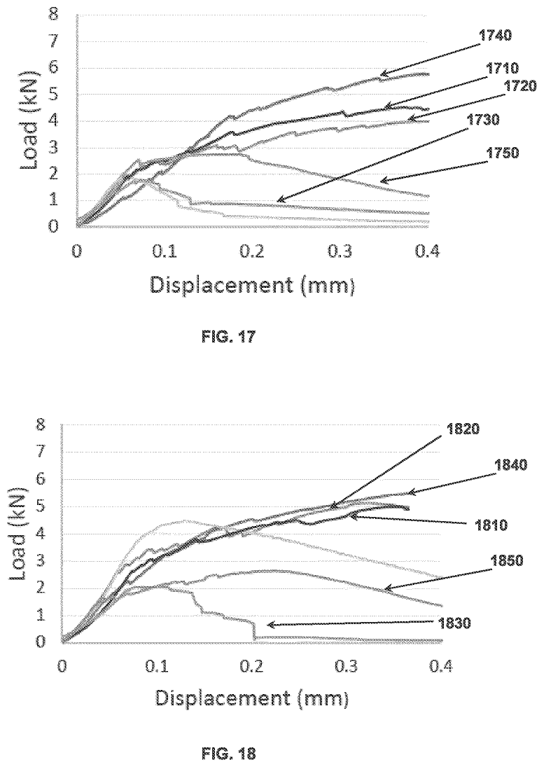

FIG. 18 illustrates a flexural response of cementitious mixtures with 0.6 mm sand size and varying fiber ratios, according to embodiments, up to a total deflection of 0.4 mm. FIG. 18 shows the flexural response of a cementitious mixture having 2% PVA 1810, the flexural response of a cementitious mixture having 2% STF 1830. The flexural response of a cementitious mixture having a hybrid of fibers is also illustrated, namely 1% PVA+1% STF 1820, 1.5% PVA+0.5% STF 1840 and 0.5% PVA+1.5% STF 1850.

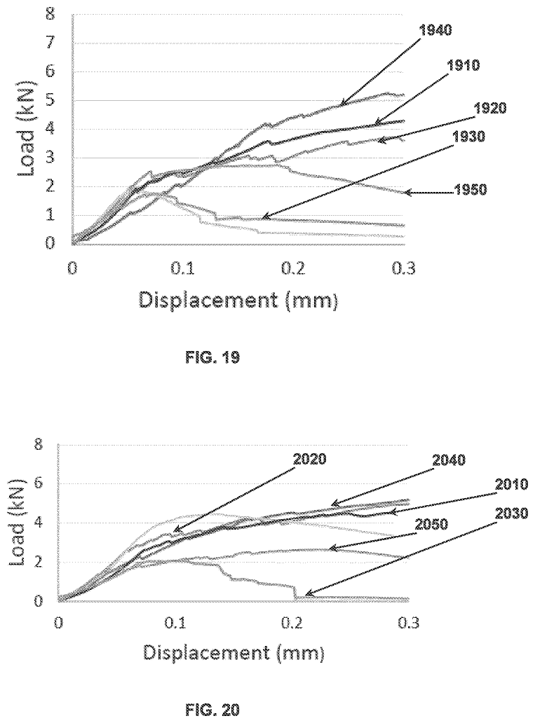

FIG. 19 illustrates a flexural response of cementitious mixtures with 0.8 mm sand size and varying fiber ratios, according to embodiments, up to a deflection of 0.3 mm. FIG. 19 shows the flexural response of a cementitious mixture having 2% PVA 1910, the flexural response of a cementitious mixture having 2% STF 1930. The flexural response of a cementitious mixture having a hybrid of fibers is also illustrated, namely 1% PVA+1% STF 1920, 1.5% PVA+0.5% STF 1940 and 0.5% PVA+1.5% STF 1950.

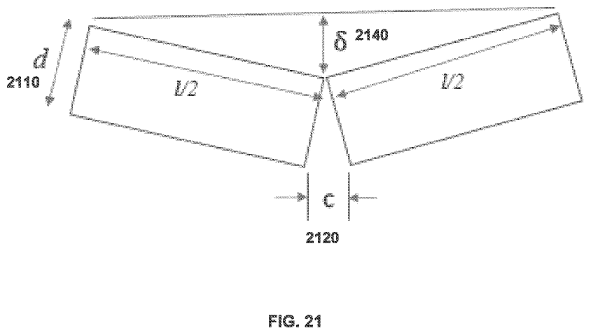

FIG. 20 illustrates a flexural response of cementitious mixtures with 0.6 mm sand size and varying fiber ratios, according to embodiments, up to a total deflection of 0.3 mm. FIG. 20 shows the flexural response of a cementitious mixture having 2% PVA 2010, the flexural response of a cementitious mixture having 2% STF 2030. The flexural response of a cementitious mixture having a hybrid of fibers is also illustrated, namely 1% PVA+1% STF 2020, 1.5% PVA+0.5% STF 2040 and 0.5% PVA+1.5% STF 2050.

It is understood, that while deflection is typically a driver for structural design, when these structures are also fabricated from reinforced concrete a further consideration is crack opening, since larger cracks enable increased ingress of contaminants which may impact the bond between concrete and the structural steel. It is understood that for serviceability requirements there can be a restriction on crack opening to less than 0.4 mm. FIG. 21 illustrates beam kinematics relating deflection (δ) 2140 to crack opening (c) 2120. The crack opening c 2120 can be determined based on the depth (d) 2110 and length (l) of the flexural specimen and the deflection δ 2140 based on Equation 1.

$$c = \frac{4 d δ}{l} \qquad ( 1 )$$

The flexural response curves, namely the load displacement curves illustrated in FIGS. 15 to 20, were integrated to obtain the area under to load displacement curves which represents absorbed energy (E(δ), also termed the fracture energy and was determined by the following equation. It is noted that for FIGS. 15 and 16, d is equal to 0.5 mm, for FIGS. 17 and 18 d is equal to 0.4 mm and for FIGS. 19 and 20 d is equal to 0.3 mm. This may be determined according to Equation 2.

E(δ)=∫₀^{d}P(δ)dδ (2)

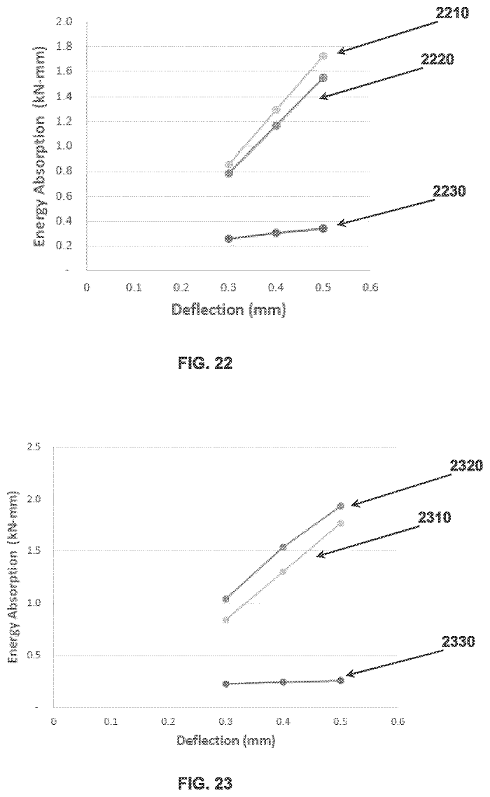

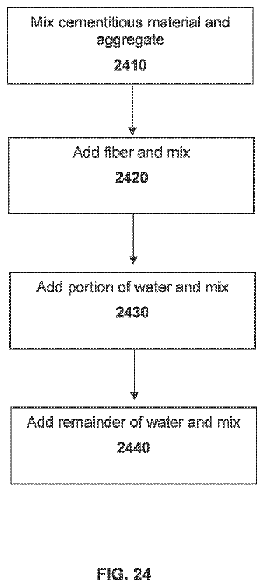

FIG. 22 illustrates energy absorption vs deflection for cementitious mixtures with sand size for varying fiber ratios, according to embodiments. With respect to FIG. 22 running values of E(δ) with respect to deflection for 2% PVA 2210; 1% PVA and 1% STF 2220; and 2% STF 2230 are plotted.

FIG. 23 illustrates energy absorption vs deflection for cementitious mixtures with sand size for varying fiber ratios, according to embodiments. With respect to FIG. 23 running values of E(δ) with respect to deflection for 2% PVA 2310; 1% PVA and 1% STF 2320; and 2% STF 2330 are plotted.

For a 0.6 mm sand content, the cementitious mixture having a hybrid fiber mix of 1% PVA and 1% STF absorbed greater energy than the industry standard 2% PVA. Given how low the energy absorption of 2% STF was observed, there is a very surprising synergy when the cementitious mixture includes a hybrid mixture of fibres. A greater absorption of energy by the cementitious mixture having a hybrid fiber mix of 1% PVA and 1% STF can make it a highly suitable material for seismic applications including seismic retrofit on various structures including unreinforced masonry, blast resistant structures, military bunkers, repairs on old concrete structures, offshore applications, shotcrete, airport runways and taxiways, large and small precast products like pipes, curtain walls, roof tiles and wavebreakers, for example

For the flexural tests is appears that STF fiber in the cementitious mixture even at 2% by volume is not able to impart any toughness. However, there is significant synergy between STF fiber and PVA fiber. In a cementitious mixture including a hybrid mix of fiber with 1% STF fiber+1% PVA fiber, the response of the cementitious mixture including a hybrid mix of fiber is almost similar to a cementitious mixture having 2% PVA fiber by volume. It is noted that at lower sand sizes of 0.6 mm, the synergy between the STF fibers and the PVA fibers results in a highly pronounced improvement in behaviour when compared to a mere additive approach of behaviours of cementitious mixtures including solely PVA and solely STF.

Based on the above experimental data, it is clear that there is an unexpected result with respect to the flexural performance of the cementitious mixture having a hybrid fiber composition, namely 1% PVA and 1% STF. This unexpected synergy between the PVA fiber and the STF fiber which can provide similar performance features of a cementitious mixture with a hybrid fiber mix with respect to a cementitious mixture with solely PVA fibers, can provide a means for not only cost savings regarding fibers but further aid with the mitigation of the waste which occurs with the recycling of tires. This is in fact a double win scenario based on the unexpected synergy of PVA and STF fibers in the performance of cementitious mixtures including the hybrid fibers therein.

According to embodiments, there are a plurality of uses for the cementitious mixture having a hybrid fiber composition. For example, possible uses or applications for the cementitious mixture having a hybrid fiber composition of the instant disclosure can include repair of structures, seismic retrofit, retaining structures, reinforced concrete structures, bridge decks, precast products, blast and impact resistant structures and the like as would be readily understood.

With respect to the repair of structures, the cementitious mixture having a hybrid fiber composition of the instant disclosure may provide a benefit of high strain capacity and improved resistance to cracking. As a result, the cementitious mixture having a hybrid fiber composition may be a useful material for repairing structures especially those with severe surface defects.

With respect to seismic retrofit, the cementitious mixture having a hybrid fiber composition of the instant disclosure may provide a high strain capacity in flexure and high energy absorption. The cementitious mixture having a hybrid fiber composition may be used for seismic retrofit of structures when applied externally as a thin coat. These structures can include unreinforced masonry walls, wood-frame structures, etc. The performance of the cementitious mixture having a hybrid fiber composition which may include high damage tolerance and the ability to deform under both tension and shear may give superior properties in a seismic retrofit project when compared to plain cement-based materials.

With respect to retaining structures, the cementitious mixture having a hybrid fiber composition of the instant disclosure may provide high deformability to conform to the applied charge. With a highly deformable nature of the cementitious mixture having a hybrid fiber composition, it may therefore be used for earth retaining structures as well as for the repair of such structures.

With respect to reinforced concrete structures, the cementitious mixture having a hybrid fiber composition of the instant disclosure may be useful for structures such as coupling beams in high rises, beam-column joints, foundations, and the like. There can be a usefulness when considering a desired mitigation of earthquake damage.

With respect to bridge decks, the cementitious mixture having a hybrid fiber composition of the instant disclosure may be used for construction as well as repair of these components.

With respect to precast products, the cementitious mixture having a hybrid fiber composition of the instant disclosure may provide a high damage tolerance which can provide a durability and resistance for precast products and thus aid with the prevention of cracking and shattering during transportation and placement of these precast products.

With respect to blast and impact resistant structures, the cementitious mixture having a hybrid fiber composition of the instant disclosure may provide a high energy absorption capacity. As such, the cementitious mixture having a hybrid fiber composition may be an excellent material for structures that are subjected to blast and impact such as defense bunkers, protective structures, anti-terrorism fences and the like.

According to embodiments, the cementitious mixture of the instant disclosure can be cast, 3D-printed, sprayed or formed or applied by other fabrication process applicable for cementitious mixtures that would be readily understood by a worker skilled in the art.

According to embodiments, there is provided a method of making a cementitious mixture, wherein the cementitious mixture includes a cementitious material, aggregate, water, a first amount of polymeric material fiber and a second amount of recycled polymeric fiber (RPF). The first amount and the second amount are defined by a ratio, the ratio between 1:7 and 7:1. The method includes mixing 2410 the cementitious material and the aggregate for a first period of time and adding 2420 the polymeric material fiber and the RPF fiber and continuing to mix for a second period of time. The method further includes adding 2430 half to three quarters of the water and continuing to mix for a third period of time and adding 2440 the remaining water and continuing to mix for a fourth period of time

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

1. A cementitious mixture comprising:
a cementitious material;
aggregate;
water;
a first amount of polymeric material fiber; and
a second amount of recycled polymeric fiber;
wherein the first amount and the second amount are defined by a ratio, the ratio between 1:7 and 7:1.

2. The cementitious mixture according to claim 1, wherein the ratio is between 1:4 and 4:1.

3. The cementitious mixture according to claim 1, wherein the ratio is between 1:3 and 3:1.

4. The cementitious mixture according to claim 1, wherein the ratio is between 1:2 and 2:1.

5. The cementitious mixture according to claim 1, wherein the ratio is between 1:1.

6. The cementitious mixture according to claim 1, wherein addition of the first amount of polymeric fiber and the second amount of recycled polymeric fiber equals a total fiber in the cementitious mixture, wherein the total fiber is between 0.1% and 4% by volume of the cementitious mixture.

7. The cementitious mixture according to claim 6, wherein the total fiber is between 1% and 3% by volume of the cementitious mixture.

8. The cementitious mixture according to claim 7, wherein the total fiber is 2% by volume of the cementitious mixture.

9. The cementitious mixture according to claim 1, wherein the cementitious material is one or more of a general use (GU) Portland cement, a high performance cement, a geopolymer cement, ordinary Portland cement (OPC), Portland limestone cement (PLC), a magnesium based binder, a phosphogypsum based binder, a biocement based binder, and a perlite based binder.

10. The cementitious mixture according to claim 1, wherein the recycled polymeric fiber is one or more of recycled polyvinyl alcohol (PVA), recycled polyethylene-terephthalate (PET), recycled polypropylene, recycled polyester, recycled cellulose and repurposed tire fiber.

11. The cementitious mixture according to claim 10, wherein the repurposed tire fiber is one or more of polyvinyl alcohol (PVA), polyethylene-terephthalate (PET), polypropylene and polyester.

12. The cementitious mixture according to claim 1, wherein the polymeric material fiber is one or more of polyvinyl alcohol (PVA), polyethylene-terephthalate (PET), polypropylene and polyester.

13. The cementitious mixture according to claim 1, wherein the aggregate is one or more of a fine aggregate, sand, a coarse aggregate, a recycled aggregate, a natural lightweight aggregate, an artificial lightweight aggregate, an alkali-activated material, waste glass and recycled glass.

14. The cementitious mixture according to claim 1, wherein the cementitious mixture further includes one or more additives, wherein the one or more additives are selected from superplasticizer, water reducer, air entrainment, retarders accelerators, internal curing compounds and sequestered carbon dioxide

15. The cementitious mixture according to claim 1, wherein the cementitious mixture is used for one or more of repair of structures, seismic retrofit, retaining structures, reinforced concrete structures, bridge decks, precast products, blast resistant structures and impact resistant structures.

16. The cementitious mixture according to claim 1, wherein the cementitious mixture is one or more of cast, 3D-printed and sprayed.

17. A method for making a cementitious mixture, the cementitious mixture including a cementitious material, aggregate, water, a first amount of polymeric material fiber and a second amount of recycled polymeric fiber (RPF), the first amount and the second amount are defined by a ratio, the ratio between 1:7 and 7:1, the method comprising:
mixing the cementitious material and the aggregate for a first period of time;
adding the polymeric material fiber and the RPF fiber and continuing to mix for a second period of time;
adding half to three quarters of the water and continuing to mix for a third period of time; and
adding remaining water and continuing to mix for a fourth period of time.
